(19) United States
(12) Patent Application Publication
(10) Pub. No.: US 2022/0284395 A1
(43) Pub. Date: Sep. 8, 2022

(54) METHOD FOR PROVIDING COMPANY SERVICE USING MOBILE BUSINESS CARD AND SERVER THEREOF

(71) Applicant: JEJECOMMS Inc., Seongnam-si, Gyeonggi-do (KR)

(72) Inventor: Joon Gang KIM, Gwangju-si (KR)

(21) Appl. No.: 17/630,225

(22) PCT Filed: Aug. 5, 2020
(86) PCT No.: PCT/KR2020/010317

§ 371 Date: Jan. 26, 2022

(30) Foreign Application Priority Data
Aug. 5, 2019 (KR) 10-2019-0094924
Aug. 3, 2020 (KR) 10-2020-0096974

(51) Int. Cl. G06Q 10/10; G06F 16/955

(52) U.S. Cl. CPC G06Q 10/10; G06F 16/955; G06Q 50/10

(57) ABSTRACT

The present invention relates to a corporate service providing method and a providing server, which use a mobile business card. More specifically, in addition to a simple information transfer function, all functions such as marketing support, work efficiency improvement, and internal solidarity reinforcement can be performed, thereby contributing to actual business activities of a corporation and resolving the lack of promptness and accuracy of information at once.

### BACKGROUND OF THE INVENTION

### 1. Technical Field

The present invention relates to a company service providing method and a providing server using a mobile business card, and more specifically, to a company service providing method and a providing server using a mobile business card, which can contribute to actual business activities of a company by performing the functions such as marketing support, work efficiency improvement, and in-house solidarity strengthening, in addition to a simple information transfer function.

### 2. Description of Related Art

A behavior of handing over a paper business card to a person meeting for work or other reasons for the first time is a very effective means for introducing a person himself or herself, as well as an organization to which the person belongs, and with the advent of Internet of Things (IoT) technology, electronic mobile business cards that can create new values by providing various additional functions, in addition to all the functions provided by existing paper business cards, have emerged.

Among the various advantages of the mobile business cards, the most prominent advantage compared to the paper business cards is expandability. Expandability literally means the property of being expanded, and mobile business cards can freely expand a virtual storage space as much as basically provided to a user by a service server that provides mobile business card service and further expand the virtual storage space by paying a relevant fee when additional storage space is required, far beyond the physical space limited to the front or back side of paper business cards that are as large as to fit in a wallet, and therefore, since there is no restriction on the type and content of information that can be stored in the storage space and provided through the mobile business cards, it can be regarded that the expandability is infinite.

With all these advantages of the mobile business cards, most mobile business card services currently on the market have a problem in that they perform only a simple information transfer function for mobile business card owners like existing paper business cards, or a function of an improved phone book added with some additional information. Although some mobile business card services replace information on a company to which the mobile business card owner belongs by providing a homepage of the company, or provide only some information by means of a predetermined form, this is information obtained through public APIs rather than information directly obtained from a person concerned in the company, and there is a problem of lacking in promptness and accuracy of information.

There is no restriction on the type and content of information on the mobile business card owner and his/her company, which can be provided through the mobile business cards, and detailed types of the provided information may vary according to a counterpart receiving the mobile business card. Therefore, an object of the present invention is to propose a new and progressive mobile business card service that can actively contribute to actual business activities of a company by solving the problems of conventional mobile business card services by high-dimensionally applying the mobile business cards, and creating new values such as marketing support, work efficiency improvement, and in-house solidarity strengthening, in addition to an information transfer function.

### DISCLOSURE OF INVENTION

### Technical Problem

Therefore, the present invention has been made in view of the above problems, and it is an object of the present invention to provide a company service providing method and a providing server using a mobile business card, which can solve lack of promptness and accuracy of information, which is a problem of conventional mobile business card services, at once by high-dimensionally applying expandability of the mobile business card.

Another object of the present invention is to provide a company service providing method and a providing server using a mobile business card, which can actively contribute to actual business activities of a company by creating new values such as marketing support, work efficiency improvement, and in-house solidarity strengthening, in addition to an information transfer function.

Technical problems of the present invention are not limited to the technical problems mentioned above, and other unmentioned technical problems will be clearly understood by those skilled in the art from the following description.

### Technical Solution

To accomplish the above objects, according to one aspect of the present invention, there is provided a company service providing method using a mobile business card, the method comprising the steps of: (a) receiving a company service sign-up application including a business number from a first terminal, and processing the company service sign-up application, by a service server; (b) receiving a company mobile business card production application including first company-related information from the first terminal, by the service server; (c) creating a company mobile business card template in response to the received company mobile business card production application, and storing the template together with the first business-related information, by the service server; (d) receiving, from the first terminal, personal information of one or more N-th users (N is a positive integer) currently employed or to be employed by a company the same as that of a first user who is a user of the first terminal, by the service server; (e) transmitting a link capable of installing a company mobile business card of the N-th user created by adding the received personal information of the N-th user to the stored company mobile business card template to an N-th terminal, which is a terminal of the N-th user, by the service server; and (f) outputting the company mobile business card of the N-th user installed by the N-th terminal by accessing the link, by the service server.

According to an embodiment, the company service providing method may further comprise, after step (f), the steps of: (g) receiving second company-related information from the first terminal or the N-th terminal, and storing the second company-related information together with the stored company mobile business card template and first company-related information, by the service server; and (h) outputting the stored second company-related information to the first terminal or the N-th terminal, by the service server.

According to an embodiment, the second company-related information may be company's internal information including one or more among general announcements of the company, emergency announcements of the company, employment of new workers, and resignation of existing workers.

According to an embodiment, the company service providing method may further comprise, after step (f), the steps of: (i) receiving a company mobile business card exchange application from the N-th terminal, and transmitting a link capable of installing the company mobile business card of the N-th user to a K-th terminal of a K-th user (K is a positive integer) currently employed or to be employed by a company different from that of the N-th user, by the service server, and (j) outputting the company mobile business card of the N-th user installed by the K-th terminal by accessing the link, by the service server.

According to an embodiment, the company service providing method may further comprise, after step (j), the steps of: (k) receiving a request for changing any one or more among the stored first company-related information from the first terminal, and changing and storing again the first company-related information, by the service server, and (l) outputting the re-stored first company-related information to the K-th terminal, by the service server.

According to an embodiment, the company service providing method may further comprise, after step (j), the steps of: (m) receiving third company-related information from an external server, and storing the third company-related information together with the stored company mobile business card template and first company-related information, by the service server; and (n) outputting the stored third company-related information to the K-th terminal, by the service server.

According to an embodiment, the third company-related information may be one or more among company stock price information, company recruitment information, and company investment information.

According to an embodiment, the business card exchange application may be any one or more among a business card exchange application using QR code shooting, a business card exchange application using NFC, a business card exchange application using a character message, and a business card exchange application using an online messenger.

According to an embodiment, the first company-related information may be sign-up information of a company including one or more among Korean name of the company, English name of the company, homepage address of the company, name of a person-in-charge, phone number of a person-in-charge, email address of a person-in-charge, representative phone number of the company, fax number of the company, business type, operation type, Korean address of the company, and English address of the company.

According to an embodiment, the first company-related information may be information on public relations of the company including one or more among information on the company, history of the company, news of the company, public relations photos/videos of the company, new product information, and new promotion information.

### Advantageous Effects

According to the present invention as described above, there is an effect of eliminating conventional troubles of requesting a paper business card production company, confirming a final version, receiving printed paper business cards, and personally giving the paper business cards to the N-th user one by one, in creating a business card of an N-th user currently employed or to be employed by a company.

In addition, since an N-th user's company mobile business card is automatically created and installed in an N-th terminal only by receiving personal information of the N-th user after accessing a service server through a company service dedicated page or a mobile business card application, it is overwhelmingly advantageous from the aspect of promptness and manufacturing cost in creating mobile business cards, and there is an effect of maximizing these advantages when there are several N-th users at the same time who need to have a new business card.

In addition, since the mobile business card application may perform a function of an in-house bulletin board, there is an effect of improving work efficiency by reducing unnecessary waste of time and strengthening solidarity by promoting friendship according to a specific type of second company-related information, and expanding the company service without limit as the types of the second company-related information are diversified.

In addition, as third company-related information is automatically provided to customer companies or business partners of a company, it does not need to separately confirm the information, and the information can be actively used for future progress of business of the company, and therefore, there is an effect of actively contributing to actual business activities.

The effects of the present invention are not limited to the effects mentioned above, and other effects not mentioned will be clearly understood by those skilled in the art from the following description.

### BRIEF DESCRIPTION OF THE DRAWINGS

FIG. 1 is a view showing the overall configuration of a service server according to a first embodiment of the present invention.

FIG. 2 is a flowchart illustrating representative steps of a company service providing method using a mobile business card according to a second embodiment of the present invention.

FIG. 3 is a view briefly describing components performing a company service providing method using a mobile business card and a process performed therebetween according to a second embodiment of the present invention.

FIG. 4 is a flowchart illustrating representative steps of a company service providing method using a mobile business card according to a third embodiment of the present invention.

FIG. 5 is a flowchart illustrating representative steps of a company service providing method using a mobile business card according to a fourth embodiment of the present invention.

FIG. 6 is a view briefly describing components performing a company service providing method using a mobile business card and a process performed therebetween according to a fourth embodiment of the present invention.

FIG. 7 is a view showing that both of two companies are companies that have signed up for a company service, and when members belonging to each company have exchanged company mobile business cards with each other, all of them may confirm third company-related information.

### BEST MODE FOR CARRYING OUT THE INVENTION

Hereinafter, preferred embodiments of the present invention will be described in detail with reference to the accompanying drawings. Advantages and features of the present invention, and a method for achieving them will become apparent with reference to the embodiments described below in detail, together with the accompanying drawings. However, the present invention is not limited to the embodiments described below, and may be implemented in various different forms. These embodiments are provided only to make the disclosure of the present invention complete and to fully inform the scope of the present invention to those skilled in the art, and the present invention is only defined by the scope of the claims. Like reference numerals refer to like elements throughout the specification.

Unless otherwise defined, all terms (including technical and scientific terms) used in this specification may be used as a meaning commonly understood by those skilled in the art. In addition, although terms defined in a generally used dictionary are not to be interpreted ideally or excessively unless clearly defined in particular, the term “company” used in this specification is the broadest concept that includes various government-affiliated organizations and even religious organizations regardless of whether it is for-profit, non-profit, or corporation, and therefore, a group of people assembled to perform a work for a common purpose may be regarded as a company.

Meanwhile, the terms used in this specification are for describing the embodiments and are not intended to limit the present invention. In this specification, singular forms also include plural forms unless specially stated otherwise in the phrase.

The terms “comprises” and/or “comprising” used in this specification mean that a mentioned component, step, operation, and/or element does not exclude presence or addition of one or more other components, steps, operations, and/or elements.

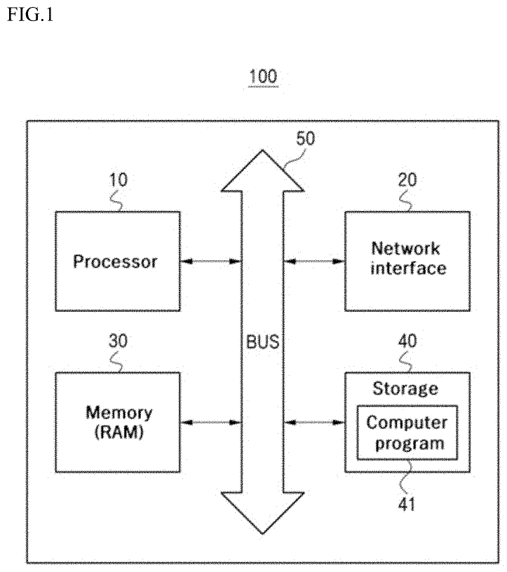

FIG. 1 is a view showing the overall configuration of a service server according to a first embodiment of the present invention.

However, this is only a preferred embodiment for achieving the objects of the present invention, and some components may be added or deleted as needed, and of course, a function performed by one component may be performed by another component.

A service server 100 according to a first embodiment of the present invention includes a processor 10, a network interface 20, a memory 30, a storage 40, and a data bus 50 connecting these components, and any practical implementation form such as a tangible physical service server including an in-house system, a space rental system, or the like, or an intangible cloud service server may be used.

The processor 10 controls the overall operation of each component. The processor 10 may be any one among a central processing unit (CPU), a microprocessor unit (MPU), a microcontroller unit (MCU), and a type of processor widely known in the art. In addition, the processor 10 may perform an operation with regard to at least one application or program for performing a company service providing method using a mobile business card according to a second embodiment of the present invention.

The network interface 20 supports wired/wireless Internet communication of the service server 100 according to a first embodiment of the present invention, and may support other known communication methods. Accordingly, the network interface 20 may be configured to include a communication module according thereto.

The memory 30 may store various information, commands and/or information, and may load one or more computer programs 41 from the storage 40 to perform a company service providing method using a mobile business card according to a second embodiment of the present invention. Although RAM is shown in FIG. 1 as the memory 30, it goes without saying that various storage media may be used as the memory 30.

The storage 40 may permanently store one or more computer programs 41 and large-scale network information 42. The storage 40 may be any one among non-volatile memory such as read only memory (ROM), erasable programmable ROM (EPROM), electrically erasable programmable ROM (EEPROM), flash memory and the like, a hard disk, a removable disk, and computer-readable recording media of an arbitrary form widely known in the technical field to which the present invention belongs.

The computer program 41 may be loaded on the memory 30, and one or more processors 10 may execute (a) an operation of receiving a company service sign-up application including a business number from a first terminal, and processing the company service sign-up application; (b) an operation of receiving a company mobile business card production application including first company-related information from the first terminal; (c) an operation of creating a company mobile business card template in response to the received company mobile business card production application, and storing the template together with the first business-related information; (d) an operation of receiving, from the first terminal, personal information of an N-th user (N is a positive integer greater than or equal to 2) currently employed or to be employed by a company the same as that of a first user who is a user of the first terminal; (e) an operation of transmitting a link capable of installing a company mobile business card of the N-th user created by adding the received personal information of the N-th user to the stored company mobile business card template to an N-th terminal, which is a terminal of the N-th user; and (f) an operation of outputting the company mobile business card of the N-th user installed by the N-th terminal by accessing the link.

The operations performed by the computer program 41 briefly mentioned so far may be regarded as a function of the computer program 41, and more detailed description will be described below in the description of a company service providing method using a mobile business card according to a second embodiment of the present invention.

The data bus 50 functions as a passage of commands and/or information between the processor 10, the network interface 20, the memory 30, and the storage 40 described above.

The service server 100 according to a first embodiment of the present invention described above may classify the first company-related information, the third company-related information, and the second company-related information described below by company and store them in an internal storage space of its own, or may transmit all of the information to an external database (not shown) to be separately stored therein. In the latter case, the information may be transmitted in real-time as soon as new inflow or outflow of information is detected, or may be transmitted at regular intervals by setting a transmission interval.

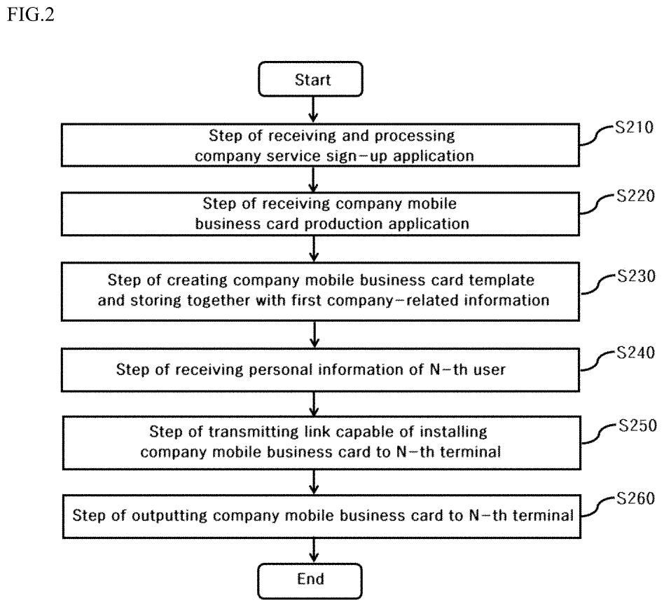

Hereinafter, a company service providing method using a mobile business card according to a second embodiment of the present invention will be described with reference to FIGS. 2 to 7.

FIG. 2 is a flowchart illustrating representative steps of a company service providing method using a mobile business card according to a second embodiment of the present invention.

However, this is only a preferred embodiment in achieving the objects of the present invention, and of course, some steps may be added or deleted as needed, and any one step may be included and performed in another step.

First, the service server 100 receives a company service sign-up application including a business number from a first terminal 200, and processes the company service sign-up application (S210).

Here, the first terminal 200 is a terminal of a person-in-charge of a company that desires to sign up for a company service, for example, a desktop computer of a human resource manager of a company may be the first terminal 200, and in addition, a terminal having a network function may be the first terminal 200.

For example, any terminal having a network function, such as a smartphone, a smart watch, a smart glass, a notebook computer, a tablet computer, a PDA, a PDP, a PMP, or the like, may be the first terminal 200.

On the other hand, the person-in-charge of a company may be a person who represents the company service sign-up application for the company as a representative of the company, regardless of the position and department in charge, such as the president of the company, a staff member of the general affairs team or the like, as well as the human resource manager of the company, and will be referred to as a first user hereinafter.

The company service sign-up application received by the service server 100 includes the business number of the company, and this is accomplished in the form of receiving the business number through an input unit (not shown) included in or connected to the first terminal 200. Here, although the input unit (not shown) varies according to the type of the first terminal 200, it may be an input means such as a keyboard, a mouse, a touchpad, a touch screen, or the like.

After confirming whether the business number of the company included in the company service sign-up application corresponds to the true business number of the company through an external database (not shown), the service server 100 receiving the company service sign-up application may approve the company service sign-up application when the business number corresponds to a true business number, or may transmit a business number correction request to the first terminal 200 when the business number does not correspond to a true business number.

In addition, when the first terminal 200 is a device that can make or receive a call, such as a smartphone or the like, the service server 100 may make a call to the first terminal 200 so that the first user may input again the business number that has been input when the company service sign-up application is submitted, and may confirm whether the input business number corresponds to the true business number of the company by comparing the input business number with the previously received business number, or may confirm the business number using a text message, mobile messenger, or the like.

Alternatively, the service server 100 may consider the business number of the company included in the company service sign-up application as being true and approve the application as it is without separate confirmation, and in this case, although the time required for the company service sign-up application may be reduced, it is possible that the first user may input a random business number rather than the true business number of the company, and therefore, it is desirable to request the first user later to upload a separate data that can confirm the business number, such as a business registration certificate or the like.

Although approval of the company service sign-up application is completed by a simple approval process when the company service itself is a free service, when the company service is a paid service that requires payment, it goes without saying that the approval process can be performed only when a payment is made through the first terminal 200, except in the case of a post-payment method. Here, the payment may use various payment methods, for example, well-known methods such as account transfer, credit card payment, check card payment, electronic money payment, and the like.

Meanwhile, a mobile business card company that operates the service server 100 will have a separate mobile business card homepage or a mobile business card application linked to the service server 100, and before step S210, the first user should visit the mobile business card homepage through the first terminal 200 or download the mobile business card application to the first terminal 200 (S205) and executes the application to perform a company membership sign-up procedure that requires input of predetermined information first, and it will be said that the company service sign-up application can be transmitted to the service server 100 only when a login process is completed after the membership sign-up procedure (S208).

When the company service sign-up application is received and processed, the service server 100 receives a company mobile business card production application including first company-related information from the first terminal 200 (S220).

Here, the company mobile business card production application including the first company-related information can be submitted on the mobile business card homepage through the first terminal 200 or on the mobile business card application executed in the first terminal 200, or can be submitted on a separate company service dedicated page by transmitting the company service dedicated page to the first terminal 200 in the form of a URL in order to provide a user interface (UI) differentiated only for the company service. In this case, a step of transmitting, by the service server 100, a link capable of connecting to the company service dedicated page to the first terminal 200 (S215) may be performed between steps S210 and S220.

The company mobile business card production application received from the first terminal 200 includes first company-related information, and here, the first company-related information is information having a very important meaning directly connected to various functions of the company service described below.

The first company-related information may be sign-up information of a company including any one or more among Korean name of the company, English name of the company, homepage address of the company, name of a person-in-charge, phone number of a person-in-charge, email address of a person-in-charge, representative phone number of the company, fax number of the company, business type, operation type, Korean address of the company, and English address of the company, or may be information on public relations of the company including one or more among information on the company, history of the company, news of the company, public relations photos/videos of the company, new product information, and new promotion information, and this will be described below.

Since the first company-related information is received as an input through an input unit (not shown) included in or connected to the first terminal 200 in the same way as the business number described above at step S210, detailed description will be omitted to avoid duplicate descriptions.

The company mobile business card production application that the service server 100 receives includes unique information acquired from the specificity of the mobile business card, as well as the first company-related information, and it is an image file representing the design of the business card. This will be described below.

Since a company that desires to sign up for a company service will be a company that has used paper business cards or a company that desires to use mobile business cards as soon as it is newly established, and will have a business card design that it desires to use in any case in the form of a paper business card or an image file, this can be applied to company services to reflect preferences of business card design according to individual companies.

The person-in-charge of the company may create an image file by photographing a paper business card through a photographing unit (not shown) included in or connected to the first terminal 200 or select a business card design image file stored in the first terminal 200 and transmit the image file to the service server 100 together with a company mobile business card production application, and although either a single side or both sides of the business card may be photographed or selected, it is preferable to photograph or select both sides since business cards using only one side are extremely rare.

Here, the name, the phone number, the email address, and the like first of the user may be written in the business card design included in the image file since what is important in the image file is design items such as background color, font, font size, font color, character spacing, and the like, rather than the detailed descriptions.

When the company mobile business card production application is received, the service server 100 creates a company mobile business card template according to the received company mobile business card production application, and stores the template together with the first company-related information (S230).

Here, the company mobile business card template is created using the image file described above, and there are two creation methods.

One is a method of manually creating a company mobile business card template with reference to an image file by a person such as a designer of a mobile business card company that operates the service server 100.

Here, the manual work does not mean 100% manual work completed by a person from the start to the end, but means that most of the steps should be performed by a person although it goes without saying that an automated design program (capture, extraction, and the like) may be used at some steps, and since it is performed by a person, distinction between the components needed for creation of a company mobile business card template and the components not needed for creation of a company mobile business card template is determined by the person within the business card design that is expressed by the image file.

Although there is a disadvantage in that it may take a long time when a company mobile business card template is manually created compared to a case of creating the company mobile business card template by an artificial intelligence template creation unit (not shown) described below since each of the steps is performed by a person, it is advantageous in that the quality can be remarkably improved compared to the company mobile business card template uniformly created by the artificial intelligence template creation unit (not shown) according to the designer's ability, and this is an advantage that can be maximized when the business card design expressed by the image file is somewhat complicated and added with aesthetic artistry.

The other one is creating a company mobile business card template by automatically distinguishing and extracting items that need to be extracted and items that do not need to be extracted from the image file by an artificial intelligence template creation unit (not shown) included in the service server 100.

Here, as the artificial intelligence template creation unit (not shown) may be regarded as a virtual component expressing the functions of the processor 10 described above with reference to FIG. 1, it may be viewed as a kind of image processing program.

For example, after analyzing the image file and extracting feature points, and primarily extracting all the components from the business card design expressed by the image file based on the extracted feature points, the artificial intelligence template creation unit (not shown) may distinguish the components needed for creation of a company mobile business card template from the components not needed.

More specifically, when a set of feature points arranged to be adjacent is recognized as characters, numbers, or the like, the artificial intelligence template creation unit (not shown) may determine that the components are not needed for creation of a company mobile business card template, and when it does not correspond to this, all of them may be determined as components needed for creation of a company mobile business card template.

Describing the reason for implementing in this way, since the characters or numbers displayed on a business card are highly likely to be personal information of the owner of the business card, it is not appropriate to include the information in the company mobile business card template, and the external features may be regarded as needed for creation of the company mobile business card template although the actual contents are not appropriate. Accordingly, the artificial intelligence template creation unit (not shown) may extract external features such as font, font size, font color, spacing, and the like from the set of feature points recognized as characters, numbers, or the like, and store the external features together with the created company mobile business card template.

As the artificial intelligence template creation unit (not shown) repeats the company mobile business card template creation process described above, data on the components needed and components not needed for creation of the company mobile business card template among the components in the object of business card may be accumulated, and by continuously learning the data, the time required for creating the company mobile business card template can be reduced, and even the quality may also be improved. When the data is not accumulated, human inspection is required to some extent, and the artificial intelligence template creation unit (not shown) will be able to advance day by day by learning even the results of human inspection.

In creating the company mobile business card template, the service server 100 may allow a person-in-charge of the company to select any one of the two methods described above by outputting a pop-up window or the like at step S230, or may allow a person-in-charge of the company to select a method of creating a company mobile business card template immediately after creating an image file by photographing the paper business card described at step S220 or to select a business card design image file stored in the first terminal 200.

When the created company mobile business card template is stored together with the first company-related information, the storage space in which the company mobile business card template and the first company-related information are stored may perform a function of a database of the company.

Here, although the company mobile business card template and the first company-related information may be classified by company and stored in the internal storage space of the service server 100, since the amount of data cannot but to increase as the number of companies increases and the number of employees belonging to the company increases, the storage space may be insufficient at a moment, and therefore, the data may be separately stored in an external database (not shown).

When a company mobile business card template is created and stored together with the first company-related information, it can be considered that the basic conditions for experiencing the company service are satisfied, and the experience subject of the company service is an employee belonging to the company and a third party who exchanges business cards with the employee of the company, and in the following description, the former is referred to as an N-th user (N is a positive integer), and the latter is referred to as a K-th user (K is a positive integer).

Here, when N is 1, it is a case where the person-in-charge of the company who has applied for the company service gives a mobile business card to himself or herself as a first user, and therefore, the description will be continued assuming that N is a positive integer of 2 or more.

The company service starts from issuing a mobile business card for an employee currently employed by the company. After step S230, the service server 100 receives personal information of one or more N-th users currently employed or to be employed by a company the same as that of the first user, who is the user of the first terminal 200, from the first terminal 200 (S240).

In this case, the subject that transmits the personal information of the N-th user to the service server 100 is the first terminal 200, and for integrated management and operation of the mobile business card issuance according to the company service, the first terminal 200, not the N-th user, more specifically, the first user who has transmitted the company service sign-up application, is the subject.

On the other hand, the personal information of the N-th user means the items to be added to the company mobile business card template created at step S230, and may be, for example, the name, mobile phone number, e-mail address, and the like of the N-th user, and since the artificial intelligence template creation unit (not shown) has determined before that the set of feature points arranged to be adjacent is a component that is not needed for creation of a company mobile business card template when the set of feature points is recognized as characters, numbers, or the like, and the personal information of the N-th user is separately received, it does not make a problem although the set of feature points recognized as characters, numbers, or the like is determined as a component that is not needed for creation of a company mobile business card template.

When the personal information of the N-th user is received, the service server 100 transmits a link capable of installing the company mobile business card of the N-th user created by adding the received personal information of the N-th user to the stored company mobile business card template to the N-th terminal 300, which is the terminal of the N-th user (S250).

Here, although a terminal having a network function like the first terminal 200 may also be the N-th terminal 300, since the N-th user will exchange mobile business cards with a K-th user described below using the N-th terminal itself, a smartphone, a smart watch, a smart glass, a PDA, a PDP, a PMP, or the like, rather than a desktop computer or a notebook computer that is not portable or somewhat inconvenient, may be more suitable as the N-th terminal 300.

When the N-th user selects the link on the N-th terminal 300, the service server 100 outputs a company mobile business card, to which the personal information of N-th user is added, to the N-th terminal 300, and the N-th user may confirm that whether his or her own personal information is properly added to the company mobile business card.

On the other hand, as the service server 100 may allow the N-th user to select whether the N-th user is a new user or an existing user of the mobile business card application, and to install a company mobile business card after the selection, the N-th user may first confirm whether the mobile business card application is installed in the N-th terminal 300 before installing the company mobile business card, and move to a download page when the mobile business card application is not installed, or forcibly execute the mobile business card application on the N-th terminal 300 when the mobile business card application is installed.

The N-th user should perform login in the executed mobile business card application, and when the N-th user is a new user, the service server 100 creates an ID and a temporary password for the N-th user by itself to be output on the N-th terminal 300. Here, the ID may be created using any one among the personal information of the N-th user received before at step S240, for example, an email address of the N-th user may be created as the ID, and the temporary password may be changed after the login is completed. On the other hand, when the N-th user is an existing user, the user may log in by inputting his or her ID and password, and when the N-th user's login is completed, installation of the company mobile business card of N-th user is completed.

When all the above steps are completed, the service server 100 outputs the N-th user's company mobile business card installed by the N-th terminal 300 by accessing the link (S260).

The N-th user's company mobile business card is output on the mobile business card application installed in the N-th terminal 300, and the N-th user may confirm his or her company mobile business card at any time by executing the mobile business card application in the N-th terminal 300.

On the other hand, the service server 100 may output the personal information of the N-th user received before at step S240 together with the company mobile business card, and furthermore, when the personal information of the N-th user includes the experience of the N-th user until present, for example, the names of companies and the lengths of employment in the past, the name of the currently employed company, and the like, the service server 100 may output a separate indication of personal career certificate when the N-th user's company mobile business card is output together with the personal information.

In this case, as the separate indication is indication of personal career certificate that the service server 100 itself guarantees, it may be displayed and output only when the N-th user has a career of being employed by a company that has signed up for the company service. This means that the service server 100 would have issued a company mobile business card to the N-th user through the company service only when the user has been employed by the company that has signed up for the company service, and the behavior itself of issuing a company mobile business card may be a proof of employment.

For example, when the personal information of the N-th user includes history of working at companies A to D in the past and history of currently working at company E, and only company A and company D are companies that have signed up for the company service, the service server 100 may output all the company A and company D when it outputs the personal information of the N-th user together with the company mobile business card, and output a separate indication for company A and company D, for which the user can prove employment by the companies that have signed up for the company service.

Here, the separate indication may include any means that can distinguish companies that the user can prove employment from the companies that the service server 100 cannot prove employment of the user, by displaying the names of the companies that the user can prove employment to be distinguished from the names of other companies, or displaying a specific picture, phrase, or the like near the names of the companies.

Until now, a company service providing method using a mobile business card according to a second embodiment of the present invention has been described. According to the present invention, in creating a business card of an N-th user currently employed or to be employed by a company, it is possible to eliminate conventional troubles of requesting a paper business card production company, confirm a final version, receive printed paper business cards, and personally give the paper business cards to the N-th user one by one. In addition, since an N-th user's company mobile business card is automatically created and installed in the N-th terminal 300 only by receiving personal information of the N-th user after accessing the service server 100 through a company service dedicated page or a mobile business card application, it is overwhelmingly advantageous from the aspect of promptness and manufacturing cost in creating mobile business cards, and this advantage can be maximized when there are several N-th users at the same time who need to make a new business card.

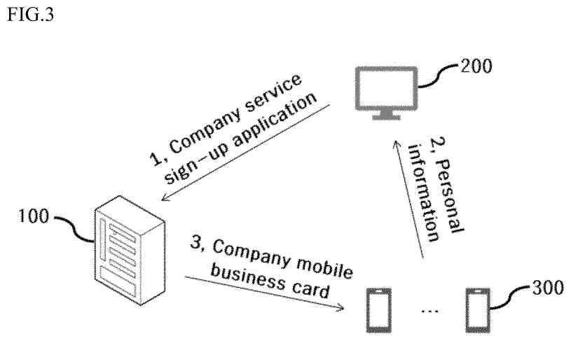

FIG. 3 is a view briefly describing components performing a company service providing method using a mobile business card and a process performed therebetween according to a second embodiment of the present invention, and it can be confirmed that when the first terminal 100, which has completed the company service sign-up application, only transmits personal information received from a plurality of N-th terminals 300 to the service server 100, the service server 100 creates and transmits company mobile business cards to the plurality of N-th terminals 300, and therefore, all the processes can be performed at once when the service server 100 is implemented as a server capable of parallel processing.

Meanwhile, since the company service providing method using a mobile business card according to a second embodiment of the present invention described above creates a company mobile business card of an N-th user currently employed or to be employed by a company, and provides the company mobile business card to the N-th terminal 300, it can be named as company service, and additional functions related to the company service, such as work efficiency improvement and in-house solidarity strengthening of workers, will be described below, and this is referred to as a company service providing method using a mobile business card according to a third embodiment of the present invention.

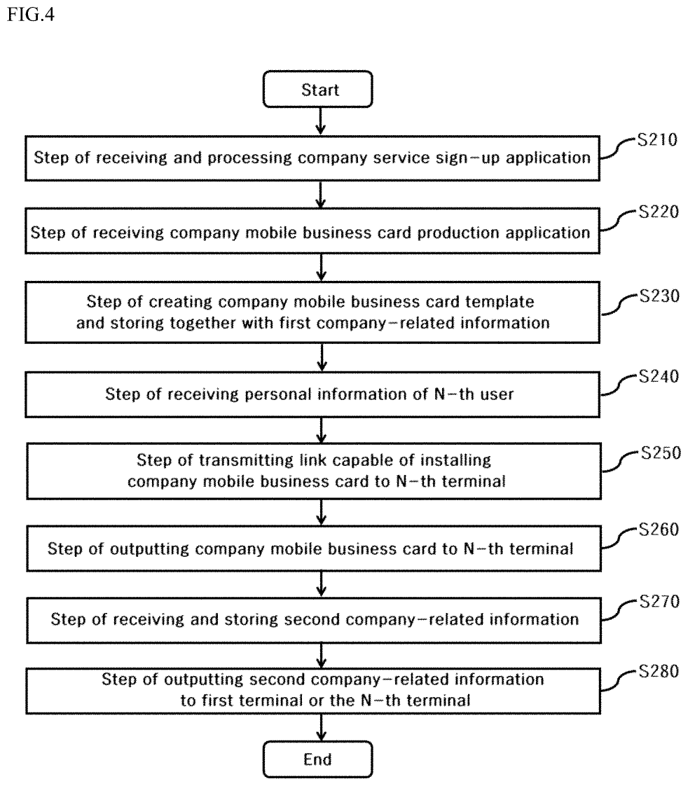

FIG. 4 is a flowchart illustrating representative steps of a company service providing method using a mobile business card according to a third embodiment of the present invention.

However, this is only a preferred embodiment in achieving the objects of the present invention, and of course, some steps may be added or deleted as needed, and any one step may be included and performed in another step.

When steps S210 to S260 are performed, it is in a state in which the N-th user's company mobile business card is installed in the N-th terminal 300, which is the terminal of the N-th user, more specifically, a mobile business card application.

After step S260, the service server 100 receives second company-related information from the first terminal 200 or the N-th terminal 300, and stores the second company-related information together with the company mobile business card template and the first company-related information stored at step S230 (S270), and the service server 100 outputs the stored second company-related information to the first terminal 200 or the N-th terminal 300 (S280).

Here, the second company-related information is company's internal information including one or more among general announcements of the company, emergency announcements of the company, employment of new workers, and resignation of existing workers, and this is an example, and any information that needs to be announced to all members of the company may be the second company-related information, and when the second company-related information is output to the terminals of all members in real-time, omission of information announcements can be prevented, and when it is information needed for a user himself or herself, work efficiency can be improved by actively using the information.

Meanwhile, as it has been described above that the subject that transmits the second company-related information is the first terminal 200 or the N-th terminal 300, and the first user is a person who represents the company service sign-up application for the company as a representative of the company, when the second company-related information is information that needs to be announced to all members belonging to the company, such as one or more among general announcements of the company, emergency announcements of the company, employment of new workers, and resignation of existing workers, it is desirable that only those members granted with special rights, not all members, are allowed to transmit the information. This is to prevent transmission of duplicate information and confusion among the members, and the corresponding member may be regarded as the first user.

Then, it needs to describe the kinds of the second company-related information that can be transmitted by the N-th terminal 300, and it is the information that is relatively less required to be announced to all members, like the second company-related information transmitted by the first terminal 200.

The second company-related information that can be transmitted by the N-th terminal 300 may be, for example, information related to the business life of the N-th user in the company, such as a business trip schedule, half-day/annual leave schedule, vacation schedule, meeting schedule, and the like of the N-th user, and when this is output to the first terminal 200 or the N-th terminal 300, other members in a business relationship or in collaboration with the N-th user may easily confirm the information without directly contacting the N-th user, and through this, unnecessary waste of time can be reduced, and work efficiency can be improved.

In addition, the second company-related information that can be transmitted by the N-th terminal 300 may also include information related to in-house solidarity strengthening, for example, a party schedule, an impromptu meeting schedule, an in-house club meeting schedule, a seminar schedule, and the like, which is information that can strengthen solidarity by relieving stress and promoting friendship with each other when a group of members meet together, and for this purpose, the first user, as well as the N-th terminal 300, may also transmit the information as the second company-related information as a member of the company.

On the other hand, apart from being able to confirm the output second company-related information by the first user or the N-th user by executing the mobile business card application in relation to output of the second company-related information, the second company-related information may be output in the form of a pop-up window or the like without executing the mobile business card application, or when the second company-related information is related to the user himself/herself, the service server 100 may transmit the second company-related information to a corresponding terminal using a text message, a mobile messenger, or the like.

According to the company service providing method using a mobile business card according to a third embodiment of the present invention described above, since the mobile business card application may perform a function of an in-house bulletin board, work efficiency can be improved by reducing unnecessary waste of time or solidarity can be strengthened by promoting friendship according to a specific type of the second company-related information, and as the types of the second company-related information are diversified, the company service may be expanded without limit. For example, when the second company-related information is member's commuting information, the mobile business card application may perform a function of an ERP system.

Since the configuration of performing the company service providing method using a mobile business card according to a third embodiment of the present invention is similar to the case of FIG. 3, separate description thereof will be omitted, and an embodiment related to business card exchange, description of which is suspended before, will be described this time, and this will be referred to as a company service providing method using a mobile business card according to a fourth embodiment of the present invention.

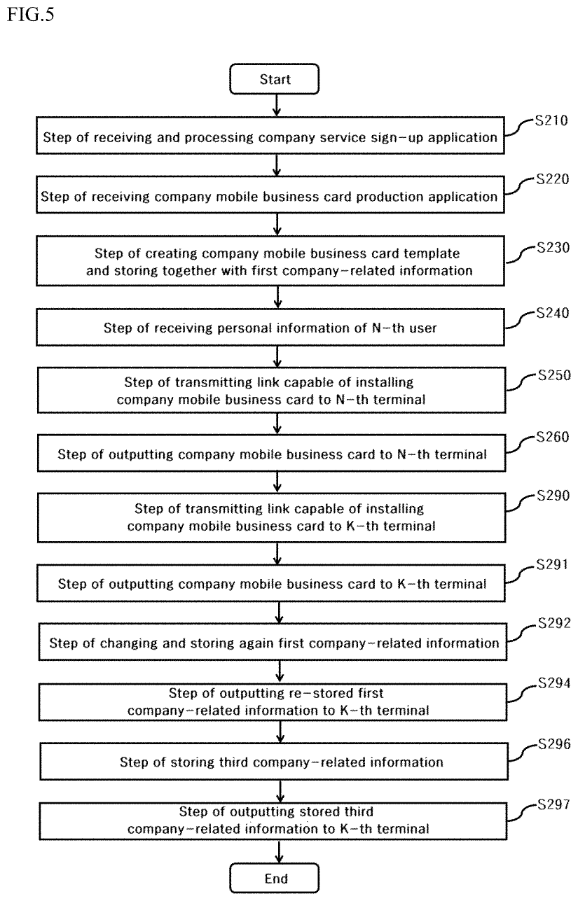

FIG. 5 is a flowchart illustrating representative steps of a company service providing method using a mobile business card according to a fourth embodiment of the present invention.

However, this is only a preferred embodiment in achieving the objects of the present invention, and of course, some steps may be added or deleted as needed, and any one step may be included and performed in another step.

When steps S210 to S260 are performed, it is in a state in which the N-th user's company mobile business card is installed in the N-th terminal 300, which is the terminal of the N-th user, more specifically, a mobile business card application.

After step S260, the service server 100 receives a company mobile business card exchange application from the N-th terminal 300, and transmits a link capable of installing the company mobile business card of the N-th user to the K-th terminal 400 of the K-th user currently employed or to be employed by a company different from that of the N-th user (S290), and the service server 100 outputs the company mobile business card of the N-th user installed by the K-th terminal by accessing the link 400 (S291).

Here, the business card exchange application is a behavior of transmitting the company mobile business card of the N-th user to the K-th user, more specifically, to the K-th terminal 400, and corresponds to the conventional behavior of handing over a paper business card to a counterpart.

On the other hand, since the company mobile business card does not have a tangible object unlike the paper business card, the business card exchange application may use the mechanical characteristics of the N-th terminal 300 itself. The business card exchange application may be any one or more among a business card exchange application using QR code shooting, a business card exchange application using NFC, a business card exchange application using a character message, and a business card exchange application using an online messenger, and it is apparent that when an independent data transmission means is provided according to the type of a terminal, the business card exchange application may be performed using the data transmission means.

In this way, it is said that a smartphone, a smart watch, smart glasses, a PDA, a PDP, a PMP, or the like is more suitable than a desktop computer, a notebook computer, or the like as the N-th terminal 300, as mentioned before the business card exchange application is performed while the N-th terminal 300 and the K-th terminal 400 are located in a relatively short distance (business card exchange application using QR code shooting, business card exchange application using NFC), or performed using a character message or an online messenger mainly used in smartphones or the like.

Since the basic principles of transmission of the link at step S290 and output of the company mobile business card at step S291 are the same as the descriptions at steps S250 and S260, detailed descriptions will be omitted to avoid duplicate descriptions, and explanations the same as those of the mobile business card application installation, ID, temporary password, login, and the like will be applied as they are.

When the process proceeds up to step S291, the mobile business card application is also installed in the K-th terminal 400, and all or part of the first company-related information may be output by the mobile business card application installed in the K-th terminal 400. There may be a case where the first company-related information like this needs to be changed after it is stored at step S230. For example, it is a case in which when the first company-related information is a company's Korean address and the company has moved, a new Korean address should be input in place of the old Korean address. This will be described below.

After step S291, the service server 100 receives a request for changing any one or more among the stored first company-related information from the first terminal 200, and changes and stores again the first company-related information (S292), and the service server 100 outputs the re-stored first company-related information to the K-th terminal 400 (S294).

In this case, unnecessary confusions can be prevented as the K-th terminal 400 may also confirm the changed first company-related information in the same manner, and apart from step S294, the service server 100 may internally announce the re-stored first company-related information to the company members by outputting the first company-related information to the first terminal 200 or the N-th terminal 300 (S295).

Furthermore, when the changed first company-related information is included in a stored company mobile business card template or is included in the company mobile business card of the N-th user created before, the service server 100 may store again the company mobile business card template or create again a company mobile business card by reflecting the changes.

On the other hand, when the K-th user is a company corresponding to a customer company or a business partner of a company where the N-th user is currently employed or to be employed, it may need to receive meaningful information related to the company where the N-th user is currently employed or to be employed (hereinafter, referred to as company A). For example, when company A has announced that it will receive a large-scale investment from a third party, this will also be informed to the K-th user so that the K-th user may actively use in the future for progress of business. This will be described below.

After step S294, the service server 100 receives third company-related information from an external server 500 and stores the third company-related information together with the company mobile business card template and the first company-related information stored at step S230 (S296), and after storing the information, the service server 100 outputs the stored third company-related information to the K-th terminal 400 (S297).

In this case, the K-th user may also be able to confirm the third company-related information in real-time, and the third company-related information may be one or more among company stock price information, company recruitment information, and company investment information, and in addition, information that can be actively used for progress of business may be third company-related information, and the external server 500 that transmits the third company-related information may be a public API server or the like.

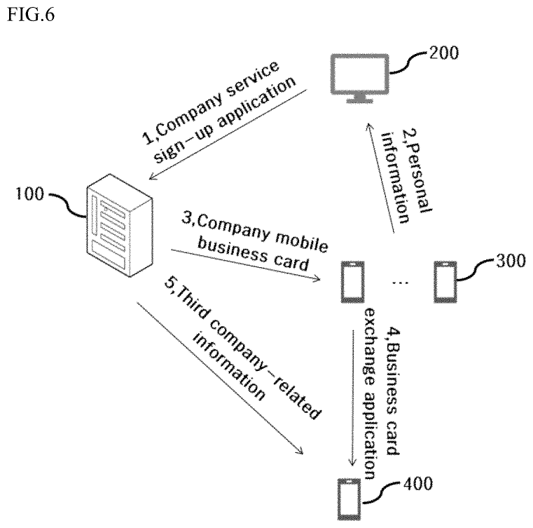

FIG. 6 is a view briefly describing components performing a company service providing method using a mobile business card and a process performed therebetween according to a fourth embodiment of the present invention. As the K-th terminal 400 receiving the company mobile business card from the N-th terminal 300 may confirm the changed first company-related information and confirm the third company-related information received from the external server 500, the information may be actively used for future progress of business of the two companies.

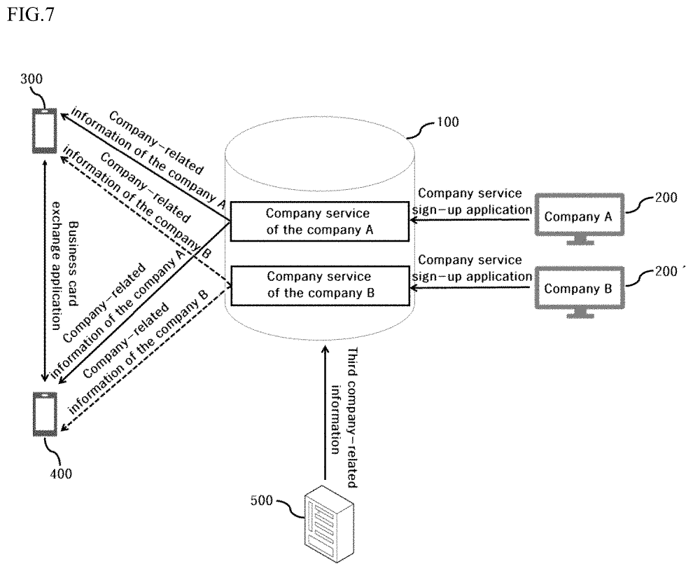

On the other hand, when the company where the K-th user is currently employed or to be employed (hereinafter referred to as company B) is also a company that has signed up for the company service like company A, and members belonging to each of the companies have exchanged company mobile business cards with each other, overwhelming convenience can be secured as all the members belonging to each of the companies may confirm all or part of the first company-related information and the third company-related information related to the counterpart companies as shown in FIG. 7, and this will be the same for the first company-related information and the second company-related information.

Until now, a company service providing method using a mobile business card according to third and fourth embodiments of the present invention has been described. According to the present invention, since work efficiency can be improved by reducing unnecessary waste of time or solidarity can be strengthened by promoting friendship according to specific types of the second company-related information and the third company-related information, and the information can be actively used for future progress of business of the company, it may actively contribute to actual business activities.

In addition, the company service providing method using a mobile business card according to second to fourth embodiments of the present invention may support even the marketing. When the first company-related information, description of which is suspended before, is information on the public relations of the company, even the K-th terminal 400 may confirm the first company-related information, and therefore, a natural marketing effect can be obtained without the need of investing a separate marketing cost.

Since the company service providing method using a mobile business card according to second to fourth embodiments of the present invention can be implemented as a computer program stored in a medium according to a fifth embodiment of the present invention including all the same technical features, it will not be described in detail to avoid duplicate descriptions. However, it is apparent that all of the technical features applied to the company service providing method using a mobile business card according to second to fourth embodiments of the present invention described above can be equally applied to the computer program stored in the medium according to the fifth embodiment of the present invention.

Although the embodiments of the present invention have been described above with reference to the accompanying drawings, those skilled in the art may understand that the present invention can be implemented in other specific forms without changing the technical spirit or essential features. Therefore, it should be understood that the embodiments described above are illustrative and not restrictive in all respects.

1. A company service providing method using a mobile business card, the company service providing method comprising the steps of:
(a) receiving a company service sign-up application including a business number from a first terminal, and processing the company service sign-up application, by a service server;
(b) receiving a company mobile business card production application including first company-related information from the first terminal, by the service server;
(c) creating a company mobile business card template in response to the received company mobile business card production application, and storing the template together with the first business-related information, by the service server;
(d) receiving, from the first terminal, personal information of one or more N-th users (N is a positive integer greater than or equal to 2) currently employed or to be employed by a company the same as that of a first user who is a user of the first terminal, by the service server;
(e) transmitting a link capable of installing a company mobile business card of the N-th user created by adding the received personal information of the N-th user to the stored company mobile business card template to an N-th terminal, which is a terminal of the N-th user, by the service server; and
(f) outputting the company mobile business card of the N-th user installed by the N-th terminal by accessing the link, by the service server.

2. The company service providing method according to claim 1, further comprising, after step (f), the steps of:
(g) receiving second company-related information from the first terminal or the N-th terminal, and storing the second company-related information together with the stored company mobile business card template and first company-related information, by the service server; and
(h) outputting the stored second company-related information to the first terminal or the N-th terminal, by the service server.

3. The company service providing method according to claim 2, wherein the second company-related information is company's internal information including one or more among general announcements of the company, emergency announcements of the company, employment of new workers, and resignation of existing workers.

4. The company service providing method according to claim 1, further comprising, after step (f), the steps of:
(i) receiving a company mobile business card exchange application from the N-th terminal, and transmitting a link capable of installing the company mobile business card of the N-th user to a K-th terminal of a K-th user (K is a positive integer) currently employed or to be employed by a company different from that of the N-th user, by the service server, and
(j) outputting the company mobile business card of the N-th user installed by the K-th terminal by accessing the link, by the service server.

5. The company service providing method according to claim 4, further comprising, after step (j), the steps of:
(k) receiving a request for changing any one or more among the stored first company-related information from the first terminal, and changing and storing again the first company-related information, by the service server, and
(l) outputting the re-stored first company-related information to the K-th terminal, by the service server.

6. The company service providing method according to claim 4, further comprising, after step (j), the steps of:
(m) receiving third company-related information from an external server, and storing the third company-related information together with the stored company mobile business card template and first company-related information, by the service server; and
(n) outputting the stored third company-related information to the K-th terminal, by the service server.

7. The company service providing method according to claim 6, wherein the third company-related information is one or more among company stock price information, company recruitment information, and company investment information.

8. The company service providing method according to claim 4, wherein the business card exchange application is any one or more among a business card exchange application using QR code shooting, a business card exchange application using NFC, a business card exchange application using a character message, and a business card exchange application using an online messenger.

9. The company service providing method according to claim 1, wherein the first company-related information is sign-up information of the company including one or more among Korean name of the company, English name of the company, homepage address of the company, name of a person-in-charge, phone number of a person-in-charge, email address of a person-in-charge, representative phone number of the company, fax number of the company, business type, operation type, Korean address of the company, and English address of the company.

10. The company service providing method according to claim 1, wherein the first company-related information is information on public relations of the company including one or more among information on the company, history of the company, news of the company, public relations photos/videos of the company, new product information, and new promotion information.
